(19) United States
(12) Patent Application Publication
(10) Pub. No.: US 2003/0127834 A1
(43) Pub. Date: Jul. 10, 2003

(54) Swiveling drywall cart

(76) Inventor: William E. Click, Grand Island, NY (US)

Correspondence Address: WALLACE F. NEYERLIN, Esq., 728 Division Avenue, Niagara Falls, NY, 14305, US

(21) Appl. No.: 10/041,990

(22) Filed: Jan. 9, 2002

(51) Int. Cl. B62B 5/00

(52) U.S. Cl. 280/651; 280/47.34

(57) ABSTRACT

A drywall cart that swivels in such a way as to be able to easily load the drywall onto elevators and to also be able to easily unload the drywall out of elevators.

An object of the invention is to be able to “swivel” a lot of sheets of drywall at one time onto the typical size passenger elevator.

Another object of the invention is to design a cart that allows the maneuverability necessary to enable one man to use the hand truck or cart to carry or position ten sheets of drywall (4 ft×8 ft) or the weight of about 1000 pounds through a 42-inch by 7-foot high elevator doorway with the depth of only about 5-½ feet and width of about 6 feet.

In order to achieve the above-defined object or goal to rotate or position drywall in a way as to enter the drywall into elevators and also to unload the drywall from elevators, one must be able to rotate or swivel the drywall from a pivoting point at about the center of the load. The cart of the present invention allows this maneuverability.

Another object of the invention is to provide building contractors with a device that provides considerable labor saving costs in transporting sheets of drywall into upper stories of buildings under construction using many sheets of drywall in said upper stories.

Drywall typically comes in sizes of 4 feet wide and 8 feet long and about ½ to ⅝ inches thick; although some drywall pieces come in lengths of 8 ½ feet and also 9 feet. The drywall cart of the present invention can maneuver drywall sheets of any of these lengths.

### BACKGROUND OF THE INVENTION

1. Field of the Invention

This invention relates to a drywall cart that swivels in such a way as to be able to easily load the drywall onto elevators and to also be able to easily unload the drywall out of elevators.

2. Description of the Related art

A search was carried out in the U.S. Patent Office to explore as to the novelty of the present invention. The field of search included Class 280, sub-classes 615, 615.1, 47.26, 47.31, 47.34, 47.35, 79.11, 79.3, and 79.7; and Class 414, sub-class 11.

The following patents were selected as those believed to be the most relevant to the present invention, but their teachings either taken singly, or in combination thereof are not considered to be anticipatory of the present invention: U.S. Pat. Nos. 3,698,577; 4,339,219; 5,762,348; 4,810,151; 4,978,132; 3,540,753; 6,032,966; 5,584,635; and 5,460,469.

### SUMMARY OF THE INVENTION

An object of the invention relates to a device design that enables the easy loading of large amounts of drywall onto elevators and also the easy unloading of the drywall from the elevators.

Another object of the invention is to be able to “swivel” a lot of sheets of drywall at one time onto the typical size passenger elevator. Webster's New World Dictionary, Third College Edition defines “swivel” as a coupling device that allows free turning of the parts attached to it; specifically a chain link made in two parts, one piece fitting like a collar below the bolt head of the other and turning freely about it; and “swiveling” as to cause to turn or rotate on or as if on a swivel. The same dictionary defines the word “swoop” as to descend suddenly and swiftly, as a bird in hunting; pounce or sweep (down or upon).

The motion sought to be achieved with the drywall loaded and unloaded by the apparatus of the present invention is a kind of a combination of the above-defined terms except with regard to the swiftness as to “swooping”.

Another object of the invention is to design a cart that allows the maneuverability necessary to enable one man to use the hand truck or cart to carry or position ten sheets of drywall (4 ft×8 ft) or the weight of about 1000 pounds through a 42-inch by 7-foot high elevator doorway with the depth of only about 5-½ feet and width of about 6 feet.

In order to achieve the above-defined object or goal to rotate or position drywall in a way as to enter the drywall into elevators and also to unload the drywall from elevators, one must be able to rotate or swivel the drywall from a pivoting point at about the center of the load. The cart of the present invention allows this maneuverability.

It is another object of the invention to provide building contractors with a device that provides considerable labor saving costs in transporting sheets of drywall into upper stories of buildings under construction using many sheets of drywall in said upper stories.

Drywall typically comes in sizes of 4 feet wide and 8 feet long and about ½ to ⅝ inches thick; although some drywall pieces come in lengths of 8 ½ feet and also 9 feet. The drywall cart of the present invention can maneuver drywall sheets of any of these lengths.

### BRIEF DESCRIPTION OF THE DRAWINGS

FIG. 1 is a side view of the dry wall carrying and swiveling cart device.

FIG. 1a is a front view of the dry wall carrying and swiveling cart device.

FIG. 1b is a top view of the dry wall carrying and swiveling cart device.

FIGS. 2, and 2a illustrate side views of the cart device showing schematically the simultaneous raising, rotating, and swiveling or swoop g of upper frame of the swiveling cart device (as compared to the lifting device in its “rest” position as illustrated in FIG. 1.).

FIG. 3 is a front view of the device showing schematically the lifting and rotating of the upper frame of the cart device wherein the upper frame rotates and swivels in the opposite direction than that as illustrated in FIGS. 2, and 2a.

FIG. 4 is a view from the back of the device to illustrate schematically the multiple positions that the upper frame of the device goes through as the user or the device swivels the drywall cart into or out of an elevator.

FIGS. 5, 5a, and 5b are side, front and top views, respectively, of the lift supporting means of the dry wall swiveling cart.

FIGS. 6, 6a, and 6b are side, font and top views, respectively, of the top lift frame of the swiveling cart device; FIG. 6c is a top view of the top i&t frame with its extension arm removed.

### DETAILED DESCRIPTION OF THE DRAWINGS AND OF THE PREFERRED EMBODIMENTS

In all of the Figures, the numeral 1 refers to the upper drywall tubing frame. The frame itself, without extension arms attached thereto, will preferably be about 85 to about 86-½ inches long and 32 inches wide. This frame will typically weigh between about 40 and 50 pounds and be constructed of about 1 ¼ inch square steel tubing with a wall thickness of about ⅛ inch.

Numeral 2 in each Figure refers to the drywall lower frame tubing support, which preferably is about 36 inches long and 30 inches wide. This frame tubing will typically be constructed of about 1/½ inch square steel tubing with a wall thickness of about ⅛ inch. Numeral 3 refers to four wheel assembly supports under the lower frame, said wheels and supports measuring about 10 inches high. The wheels themselves will preferably be about 9 inches in diameter, each with a load rating for about 750 pounds; and best if all of the wheels swivel. Numeral 4 refers to a channel brace about 4 inches wide for the upper frame and numeral 5 refers to an angle support bracket under the channel brace to reinforce same and provide the required strength to support the drywall to be loaded onto the upper frame. Numeral 6 refers to an attachment disc about 11 inches wide with two holes therein for the insertion of locking pegs 12 therein. Numeral 7 refers to a crank-lift assembly (with a crank handle 7a) that is of the necessary strength to support the upper frame with the drywall loaded on same, and flexibility to allow the maneuverability necessary to enable one man to use the cart and to achieve the objectives previously preferred to in the Summary of the Invention. Such “crank lift” assemblies are sold commercially by the Fulton Performance Products Company of Montinee, Wis., but any strong means of raising the intended load can be used such as hydraulic or screw jacks or a rack and pinion, etc. Numeral 8 refers to removable extension arms (about 20 inches long with a depth of about 9 inches) for the upper frame 1 of the device and numeral 9 refers to capped ends of the extension arms 8. Extension arms 8 have extension holes 11 therein for the insertion of thru bolts 10 therein to securely attach the extension arms 8 to the legs of the upper frame.

Locking pegs 12 are for insertion into the two holes of attachment disc 6 to insure providing the required strength for holding the drywall to be loaded onto the upper frame.

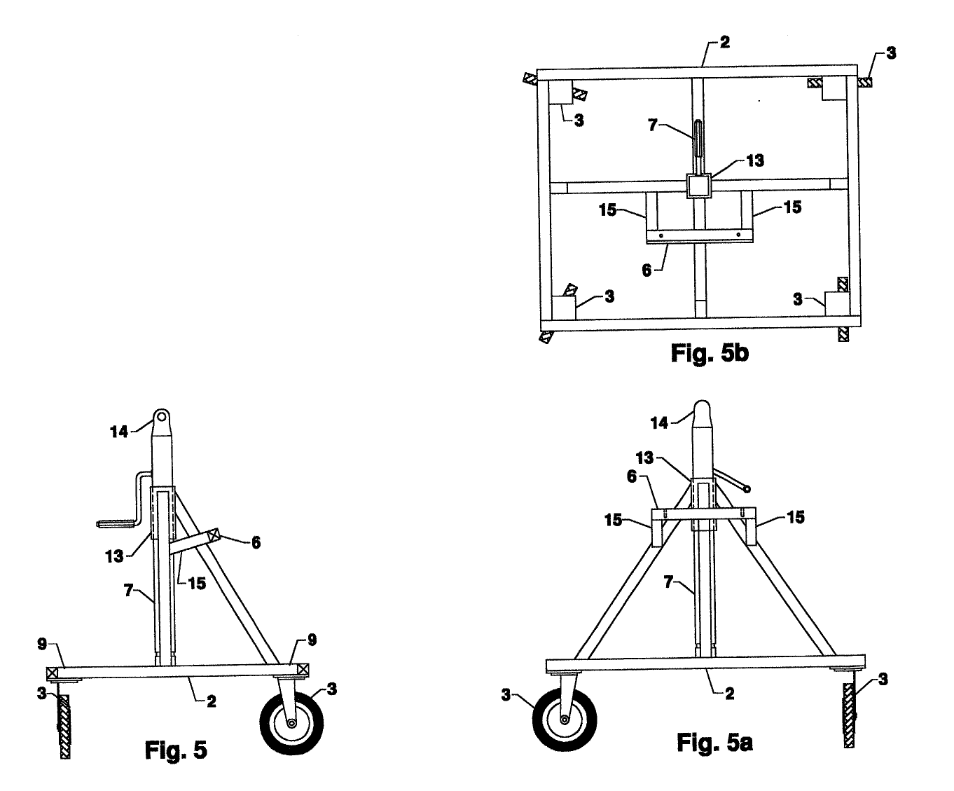

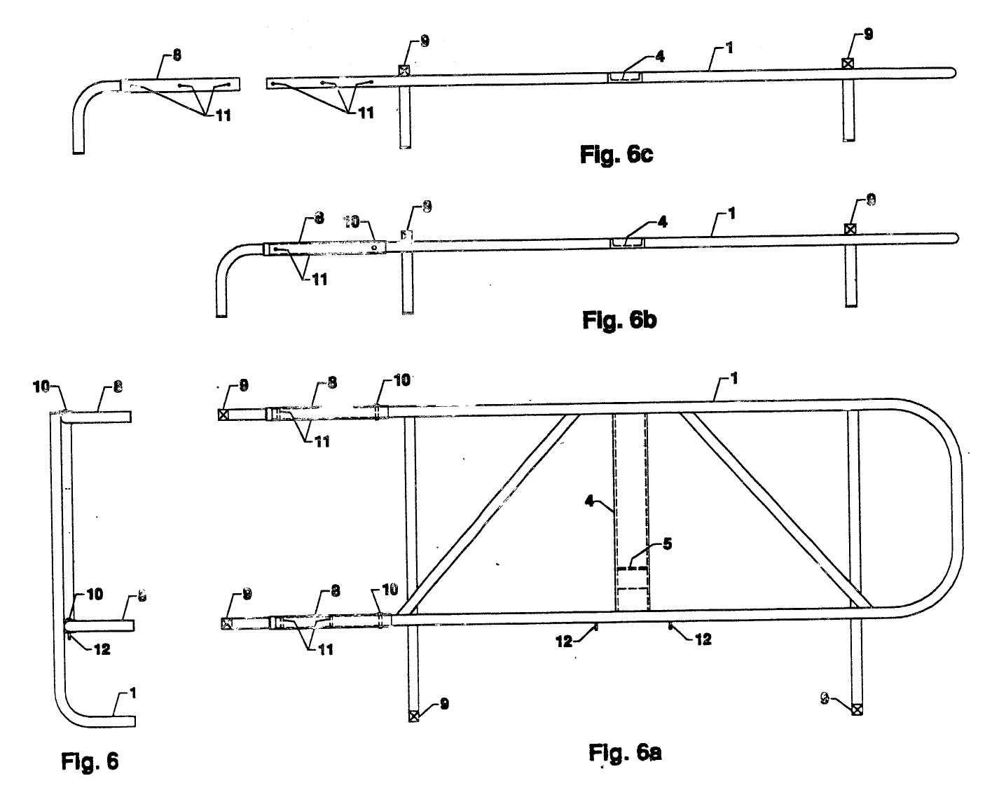

Numeral 13 denotes a portion of the lift assembly to support the frame to be attached to the crank lift assembly 7. Crank lift assembly (with handle 7a) slides inside lift assembly 13. Lift assembly 13 is typically about 2 ½ inch square steel tubing with about a wall thickness of ⅛ inch and a length of about 6 to 8 inches. Crank lift assembly 7 is about 30 inches long in its rest position illustrated in FIG. 5a; and in its extended position will be about 34 inches in height for 4 foot×8 foot drywall pieces to a maximum length or height of about 38 inches for drywall pieces 9 foot long. Numeral 14 denotes a ball joint pivot hinge at the top of the crank lift assembly 7 that assists in providing the desired and necessary rotatability and swiveling of the upper frame with the drywall loaded thereon. Item 14 could be a universal joint or a constant velocity (CV) joint, etc. Numeral 15 denotes a brace for the attachment disc 6, again to insure the strength necessary to support the intended drywall to be loaded onto the upper frame.

Besides elements 6, 7, 7a, 13, 14 and 15 the lift assembly portion of the drywall cart device comprises 3 stabilizing braces 16 welded at their tops to the underside of attachment tube 6; and at their bottoms to the top surface of the lower frame 2. These braces are each about 22 inches long and typically are of steel tubing about 1 ¼ inch square with a wall thickness of about ⅛ inch.

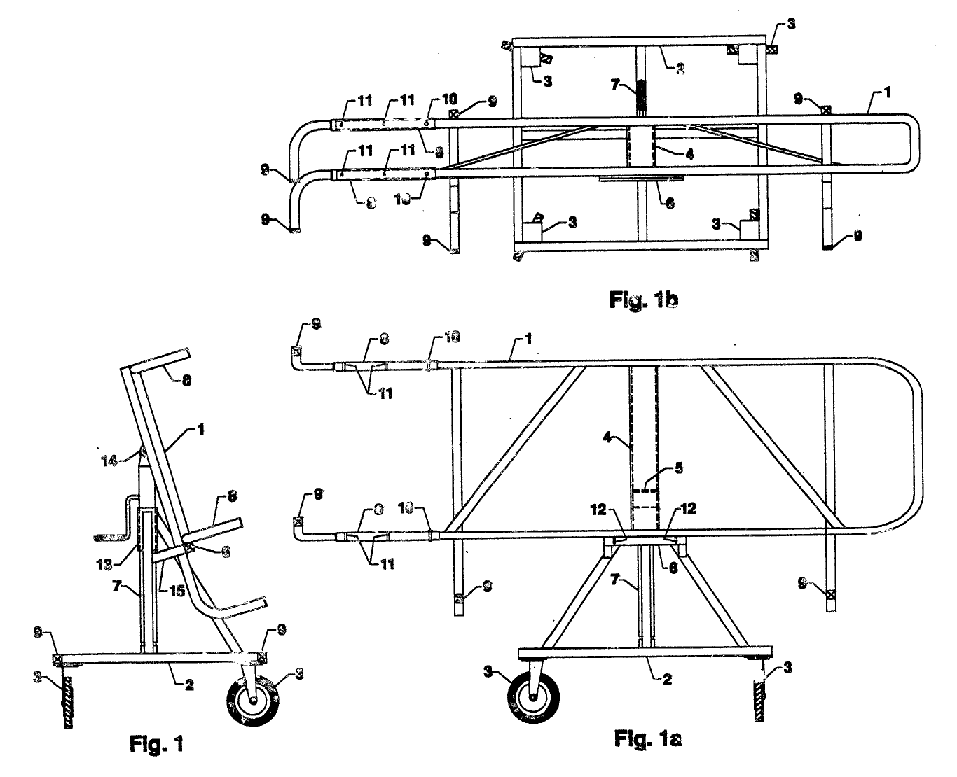

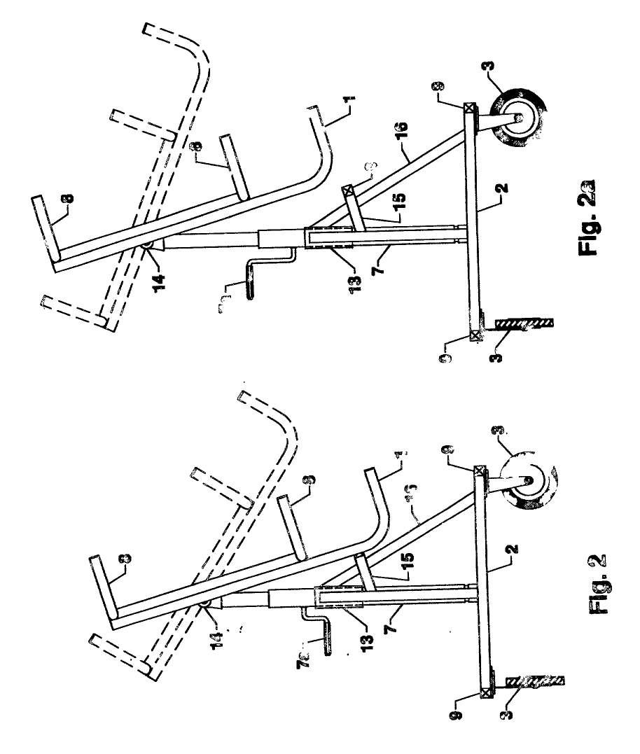

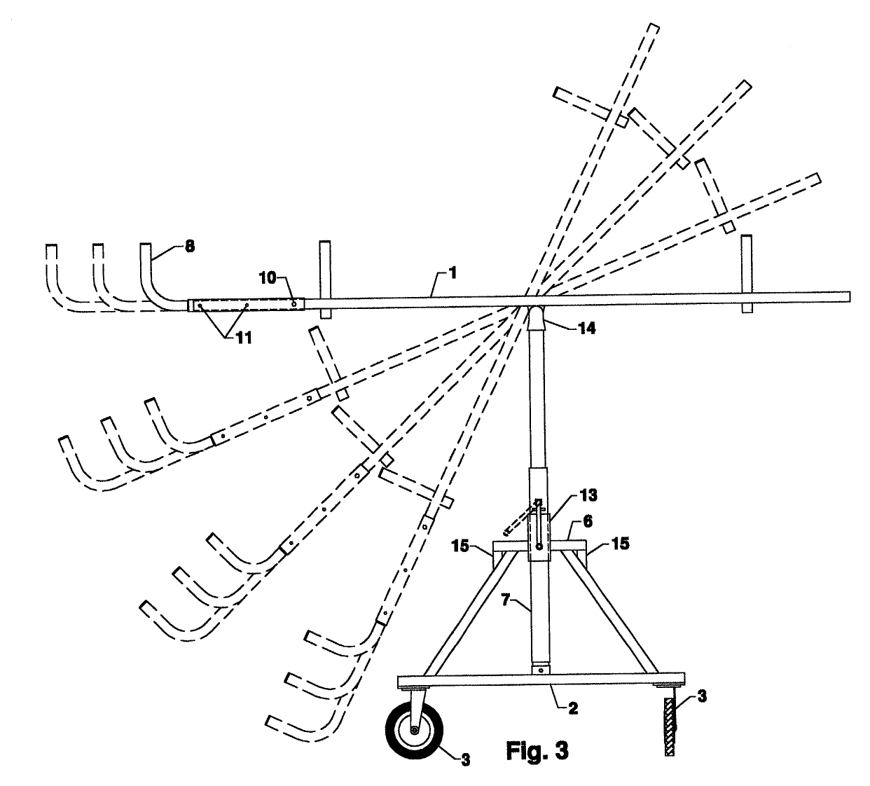

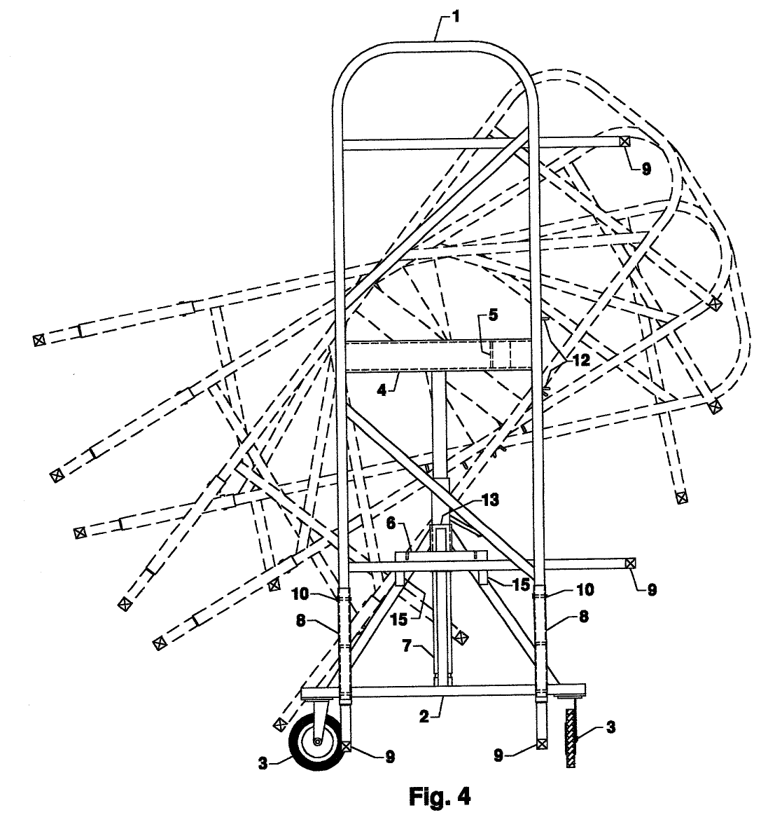

In order to achieve the desired amount of swiveling and maneuverability of the drywall loaded onto the upper frame the lift assembly must include two key elements, a means for raising and lowering the height of the upper frame; and also means for rotating or swiveling the upper frame. The height dimensions of the lower frame and of the lift assembly supporting the upper frame are important. The height of the four wheels and of their four supports should be about 10 inches to the bottom of the lower frame. The distance from the top surface of the lower frame tubing support to the top of the ball joint pivot hinge 14 should be about 30 inches when the lift assembly 13 is in an unextended height condition, as shown in FIG. 1. The distance from the top surface of the lower frame tubing support to the top of the ball joint pivot hinge 14 changes substantially as the lift assembly 7 and 13 is raised (by cranking 7a) to elevated positions shown in FIGS. 2 and 2a.

Such height dimensions as just discussed are important in order that the upper drywall frame not be too close to the ground or floor when being loaded, for convenience in loading the drywall onto the frame at an efficient height and also so as not to require undesirable amount of lifting the drywall onto the upper frame.

While the present invention has been described and illustrated in detail, various modifications may be made by those skilled in the art. It is therefore to be understood that the invention is not to be limited to the details of construction described and illustrated and it is intended by the appended claims to cover all modifications which fall within the spirit and scope of the invention.

I claim:

1. A swiveling drywall cart having an upper frame and a lower frame and a lift assembly between the upper and lower frame, said cart being capable of swiveling in such a way as to be able to easily load drywall contained by the upper frame onto elevators and to also be able to easily unload the drywall out of elevators.

2. A swiveling drywall cart having an upper frame and a lower frame and a lift assembly between the upper and lower frame, said cart being capable of swiveling in such a way as to be able to easily load drywall contained by the upper frame onto elevators and to also be able to easily unload the drywall out of elevators;
the width portion and the length portion of the upper frame each having at least two extension arms for the purpose of and capable of supporting drywall loaded onto the cart at one side and at one end of any drywall loaded onto the cart.

3. A swiveling drywall cart according to claim 1 wherein said lower frame comprises:
a rectangular tubular frame about 30 inches wide and about 36 inches long;
braces between the sides and ends of the frame at about the midpoints of the sides and ends of the frame to provide reinforcement for same; and wheels beneath the four corners of the rectangular frame to enable the rolling of the drywall cart into and out of elevators.

4. A swiveling drywall cart according to claim 1 wherein said lift assembly comprises:
means for changing the distance between the upper frame and the lower frame;
means for supporting the weight of the upper frame and the drywall loaded upon same; and
means for swiveling the upper frame loaded with drywall.

5. A swiveling drywall cart according to claim 1 wherein said upper frame comprises:
a rigid U-shaped tubular frame the main portion of which is about 26 inches wide and about 85 inches long;
a channel brace about 4 inches wide between the width sides of the frame;
an angle support bracket beneath the channel brace to provide reinforcement for same;
the width portion and the length portion of the frame each having at least two extension arms for the purpose of and capable of supporting drywall loaded onto the cart at one side and at one end of the any drywall loaded onto the cart.

6. A swiveling drywall cart having an upper frame and a lower frame and a lift assembly between the upper and lower frame, said cart being capable of swiveling in such a way as to be able to easily load drywall contained by the upper frame onto elevators and to also be able to easily unload the drywall out of elevators; said upper frame comprising:
a rigid U-shaped tubular frame the main portion of which is about 26 inches wide and about 85 inches long;
a channel brace between the width sides of the frame;
an angle support bracket beneath the channel brace to provide reinforcement for same;
the width portion and the length portion of the frame each having at least two extension arms for the purpose of and capable of supporting drywall loaded onto the cart at one side and at one end of the any drywall loaded onto the cart;
said lower frame comprising:
a rectangular tubular frame about 30 inches wide and about 36 inches long;
braces between the sides and ends of the frame at about the midpoints of the sides and ends of the frame to provide reinforcement for same; and wheels beneath the four corners of the lower rectangular frame to enable the rolling of the drywall cart into and out of elevators;
and said lift assembly comprising: means for changing the distance between the upper frame and the lower frame;
means for supporting the weight of the upper frame and the drywall loaded upon same; and means for swiveling the upper frame loaded with drywall.

7. A swiveling drywall cart according to claim 6 wherein said channel brace of the upper frame is about four inches wide.

8. A swiveling drywall cart according to claim 1 wherein the cart swivels from a pivoting point about the center of the load.

9. A swiveling drywall cart according to claim 2 wherein the cart swivels from a pivoting point about the center of the load.

10. A swiveling drywall cart according to claim 6 wherein the cart swivels from a pivoting point about the center of the load.
